(19) United States
(12) Patent Application Publication
(10) Pub. No.: US 2010/0084225 A1
(43) Pub. Date: Apr. 8, 2010

(54) Secondary Brake For A Work Machine Including An Adjustable Ball Ramp Assembly

(76) Inventors: Thomas George Ore, Cedar Falls, IA (US); Richard Neville Knowles, Waterloo, IA (US)

Correspondence Address: DEERE & COMPANY, ONE JOHN DEERE PLACE, MOLINE, IL, 61265, US

(21) Appl. No.: 12/247,341

(22) Filed: Oct. 8, 2008

(51) Int. Cl. F16D 55/08; B60K 17/28

(52) U.S. Cl. 188/71.1; 180/53.1

(57) ABSTRACT

A brake for use in a work machine includes a friction disc, a ball ramp assembly, an actuator and an adjustment mechanism. The ball ramp assembly includes an inner plate, a center plate and an outer plate which are generally coaxially arranged relative to each other. The inner plate includes an outer axial face with a plurality of ball ramps, the center plate includes opposite axial faces which each have a plurality of ball ramps, and the outer plate includes an inner axial face with a plurality of ball ramps. A plurality of balls are respectively positioned within one of the plurality of balls ramps of the center plate, and also positioned within one of the ball ramps of a corresponding inner plate or outer plate. The actuator is coupled with the center plate for actuating the ball ramps. The adjustment mechanism is coupled with the inner plate or the outer plate for adjusting the ball ramp assembly relative to the friction disc.

### FIELD OF THE INVENTION

The present invention relates to work machines, and, more particularly, to secondary brake assemblies used in such work machines.

### BACKGROUND OF THE INVENTION

A work machine such as an agricultural tractor may include an internal combustion (IC) engine which provides input power to a transmission, which in turn is coupled with and drives the rear axles through a rear end differential. The transmission, rear end differential and rear axles are sometimes referred to as the “rear end” of the work machine. The transmission typically is attached to the front of and provides input power to the rear end differential. The rear end differential provides ground power to the two rear axles, and also usually includes at least one power take-off (PTO) shaft extending rearwardly within the three point hitch arrangement at the rear of the tractor.

A work machine typically includes a pair of service brakes respectively associated with the two rear axles. Typically a pair of brake pedals are located in the operator's station. The left brake pedal operates the left, rear brake and the right brake pedal operates,the right, rear brake. Depressing both brake pedals simultaneously operates both rear brakes. Each brake usually includes a hydraulically operated piston which is actuated upon depressing a corresponding brake pedal. The piston applies a biasing force against a friction disc, which in turn is backed by a reaction plate.

In the North American market, service brakes as described above are all that is typically provided within a work machine. However, in other markets such as the European (Region II) market, secondary brakes are also required in addition to the primary service brakes. Such secondary brakes typically apply a strictly mechanical biasing force, in the event of failure of the hydraulically actuated primary service brakes.

One type of secondary brake used with work machines includes a friction disc which is separate from the friction discs associated with the primary service brakes. The secondary brakes are not frequently used, and therefore the dedicated friction discs associated with the secondary brakes do not experience considerable wear.

What is needed in the art is a secondary brake for a work machine which is less complicated than other existing secondary brakes, while still being reliable and easy to use.

### SUMMARY OF THE INVENTION

The invention in one form is directed to a brake for use in a work machine. The brake includes an inner plate, a center plate and an outer plate which are generally coaxially arranged relative to each other. The inner plate includes an outer axial face with a plurality of ball ramps, the center plate includes opposite axial faces which each have a plurality of ball ramps, and the outer plate includes an inner axial face with a plurality of ball ramps. A plurality of balls are respectively positioned within one of the plurality of balls ramps of the center plate, and also positioned within one of the ball ramps of a corresponding inner plate or outer plate.

The invention in another form is directed to a brake for use in a work machine. The brake includes a friction disc, a ball ramp assembly, an actuator and an adjustment mechanism. The ball ramp assembly includes an inner plate, a center plate and an outer plate which are generally coaxially arranged relative to each other. The inner plate includes an outer axial face with a plurality of ball ramps, the center plate includes opposite axial faces which each have a plurality of ball ramps, and the outer plate includes an inner axial face with a plurality of ball ramps. A plurality of balls are respectively positioned within one of the plurality of balls ramps of the center plate, and also positioned within one of the ball ramps of a corresponding inner plate or outer plate. The actuator is coupled with the center plate for actuating the ball ramps. The adjustment mechanism is coupled with the inner plate or the outer plate for adjusting the ball ramp assembly relative to the friction disc.

The invention in yet another form is directed to a work machine, including an engine and a rear end coupled with the engine. The rear end includes a pair of rear axles and a pair of rear brakes respectively associated with each rear axle. Each rear brake includes a friction disc, a ball ramp assembly, an actuator and an adjustment mechanism. The ball ramp assembly includes an inner plate, a center plate and an outer plate which are generally coaxially arranged relative to each other. The inner plate includes an outer axial face with a plurality of ball ramps, the center plate includes opposite axial faces which each have a plurality of ball ramps, and the outer plate includes an inner axial face with a plurality of ball ramps. A plurality of balls are respectively positioned within one of the plurality of balls ramps of the center plate, and also positioned within one of the ball ramps of a corresponding inner plate or outer plate. The actuator is coupled with the center plate for actuating the ball ramps. The adjustment mechanism is coupled with the inner plate or the outer plate for adjusting the ball ramp assembly relative to the friction disc.

### BRIEF DESCRIPTION Of THE DRAWINGS

FIG. 1 is a perspective view of an embodiment of a rear end of the present invention used in an agricultural tractor;

FIG. 2 is a perspective view of the rear end differential housing of the rear end shown in FIG. 1, with the secondary brake in place within the rear end differential housing;

FIG. 3 is another perspective view of the rear end differential housing shown in FIG. 2, with the cover for the adjustment mechanism removed;

FIG. 4 is another perspective view of the rear end differential housing shown in FIGS. 2 and 3;

FIG. 5 is an interior perspective view of the rear end differential housing shown in FIGS. 2-4, showing the actuator and adjustment mechanism from within the housing;

FIG. 6 is a sectional view taken along line 6-6 in FIG. 2, illustrating parts of the primary service brake and secondary brake;

FIG. 7 is another sectional view of the secondary brake taken along line 7-7 in FIG. 2;

FIG. 8 is a sectional view of the adjustment mechanism, taken along line 8-8 in FIG. 2;

FIG. 9 is a perspective view of the actuator and adjustment mechanism engaged with the center plate and inner plate, respectively, and the rear end differential housing removed; and

FIGS. 10-15 illustrate a sequential method of assembly of the secondary brake.

### DETAILED DESCRIPTION OF THE INVENTION

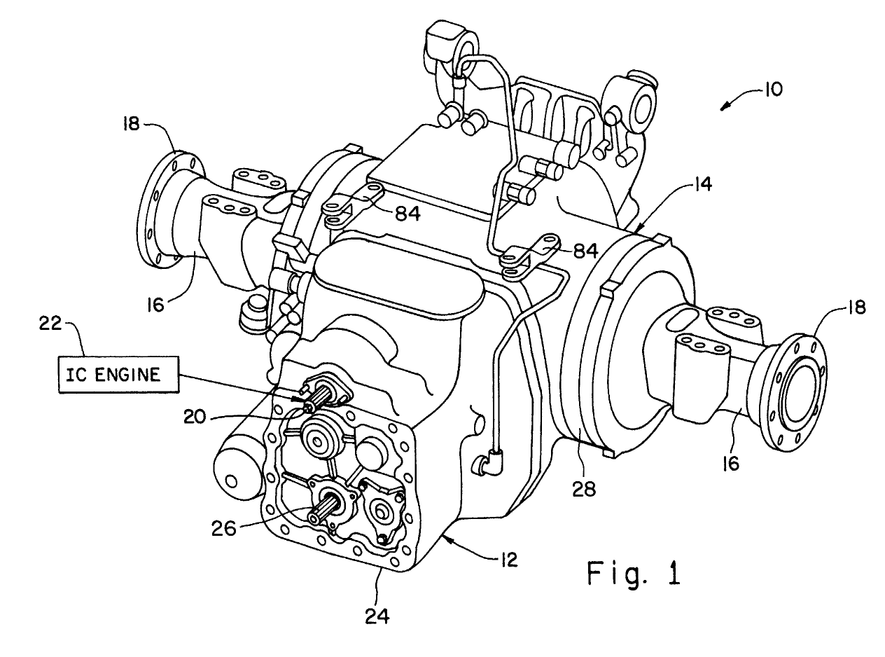

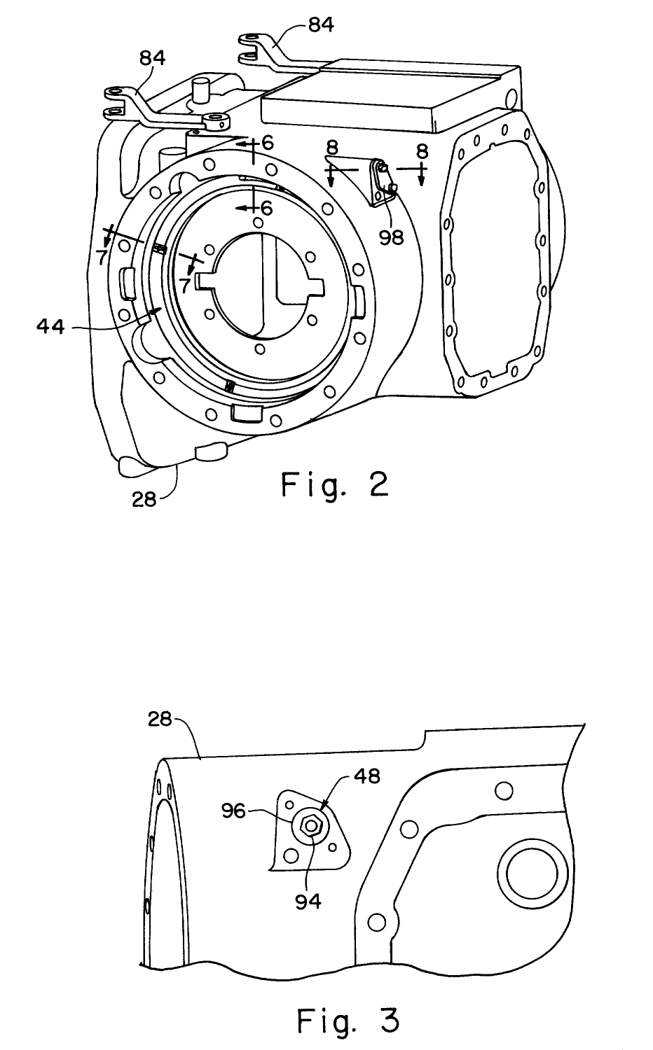

Referring now to the drawings, and more particularly to FIGS. 1 and 2, there is shown a portion of a work machine 10 in the form of an agricultural tractor, particularly the rear end drive train of the tractor. Although shown as an agricultural tractor, it is possible that work machine 10 could be in the form of a different type of work machine, such as a construction tractor or forestry machine.

Tractor 10 includes a rear end with a transmission 12 which is coupled with a rear end differential 14, which in turn drives a pair of rear axles 16. Each rear axle 16 includes an outboard hub 18 to which a respective rear drive wheel (not shown) is mounted. Although rear axles 16 are shown configured for carrying respective drive wheels, it is also possible that rear end differential 14 can be configured for driving a pair of ground engaging tracks.

Transmission 12 includes a driven shaft 20 which is mechanically coupled with and receives rotational input power from IC engine 22, shown schematically in FIG. 1. Driven shaft 20 transfers rotational power via appropriate gearing to rear end differential 14 (see FIG. 2).

Driven shaft 20 extends through and is rotatably carried by housing 24, which likewise houses and rotatably carries a number of other components. For example, housing 24 carries a mechanical front wheel drive (MFWD) module (not specifically shown) which selectively transfers output power to an output shaft 26 providing rotational output power to the MFWD at the front axle of tractor 10. A clutch arrangement (not shown) selectively interconnects with output shaft 26 so that the MFWD is engaged by actuation of a switch (not shown) in the operator's station.

Rear end differential 14 includes a rear end differential housing 28, also shown in FIGS. 2-5. Differential housing 28 carries a pair of brakes 30 of the present invention at each rear axle 16, including both a primary service brake 32 and a secondary brake 34. Only a single brake 30 is shown in FIGS. 2-4, the other brake being substantially the same.

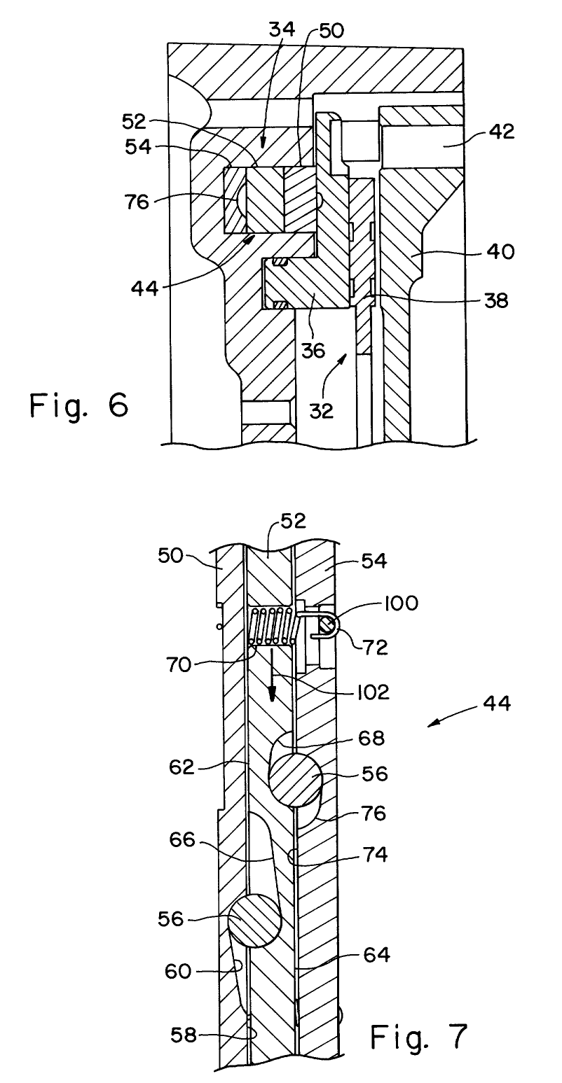

Referring to FIG. 6, primary service brake 32 generally includes a piston 36, friction disc 38 and reaction plate 40. Piston 36 is hydraulically actuated by depressing a corresponding foot pedal within the operator station, which in turn exerts a force against friction disc 38, backed by reaction plate 40. A spring loaded retractor (not shown) positioned within a passage 42 biases piston 36 in a direction away from friction disc 38 when piston 36 is not hydraulically actuated.

Secondary brake 34 likewise uses the same components making up primary service brake 32 so that an additional friction disc, etc. is not needed, thereby reducing the part count and cost. Secondary brake 34 also includes a ball ramp assembly 44, an actuator 46 and an adjustment mechanism 48.

Ball ramp assembly 44 includes an inner plate 50, a center plate 52, an outer plate 54 and a plurality of balls 56 (FIGS. 6, 7 and 9). Inner plate 50, center plate 52 and outer plate 54 are configured as generally ring-shaped discs which are generally coaxially arranged relative to each other in an area which is radially outward of piston 36. Inner plate 50 includes an outer axial face 58 with a plurality of ball ramps 60. Ball ramps 60 can generally be thought of as elongated, ramped recesses which are formed in outer axial face 58. Relative motion between inner plate 50, center plate 52 and outer plate 54 in a rotational direction in turn causes the balls carried within ball ramp 60 to vary the overall axial thickness of ball ramp assembly 44.

Center plate 52, positioned adjacent to inner plate 50, includes opposite axial faces 62 and 64 which each have a plurality of ball ramps 66 and 68. Ball ramps 66 associated with inner axial face 62 have a longer ramp than ball ramps 68 associated with outer axial face 64. The longer ball ramps associated with inner axial face 62 provide a finer adjustment of the axial thickness of ball ramp assembly 44, whereas the shorter ball ramp 68 associated with outer axial face 64 define an actuation side of ball ramp assembly 44. Center plate 52 also includes a plurality of holes 70 which receive respective tension springs 72 which sandwich the plates 50, 52 and 54 together.

Outer plate 54 similarly includes an inner axial face 74 with a plurality of ball ramps 76. Ball ramps 76 are shorter ball ramps with a length generally corresponding to ball ramp 68 on outer axial face 64 of center plate 52. Although balls 56 shown between center plate 52 and outer plate 54 are the same size as balls 56 between center plate 52 and inner plate 50, it may also be possible to provide balls between the respective plates which are different in size. That is, the balls between center plate 52 and outer plate 54 could be of a different size than the balls between center plate 52 and inner plate 50.

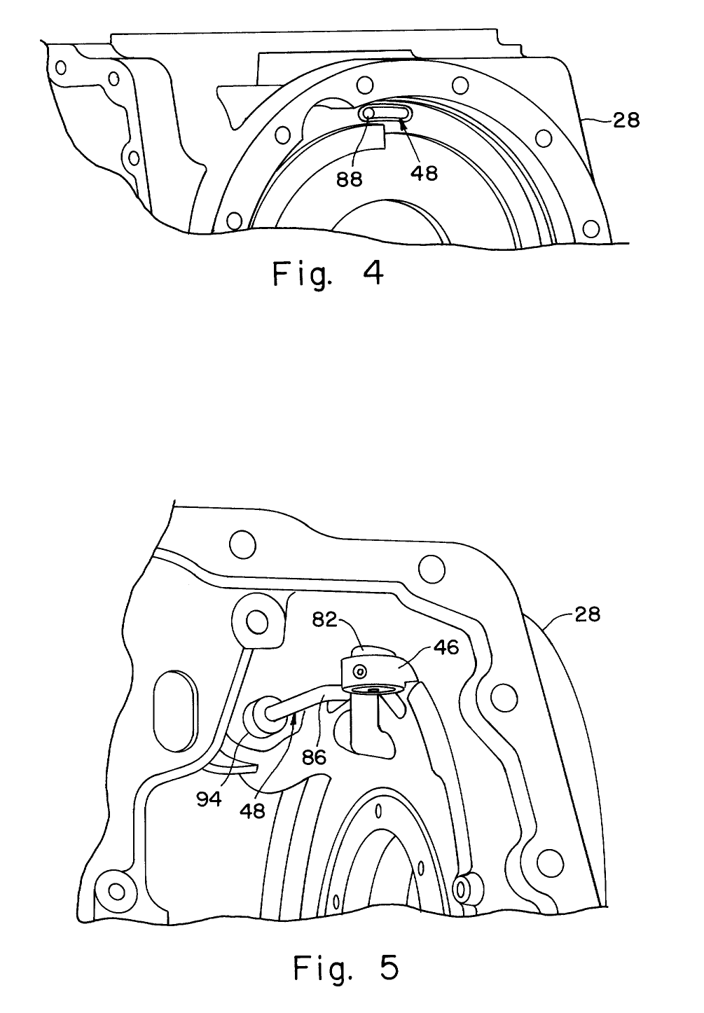

Center plate 52 also includes an ear 78 which extends radially outward from the outer periphery of the remainder of center plate 52. Ear 78 includes an opening 80 which is sized and shaped to receive an actuator 46 carried by rear end differential housing 28 (FIGS. 5 and 9). Actuator 46 is attached to a rod 82 extending through differential housing 28, which in turn is coupled with an actuation lever 84 at the exterior of differential housing 28. Actuation lever 84 is sortably configured to couple with a manually actuated linkage or the like to engage secondary brake 34 through the use of actuator 46. Adjustment mechanism 48 is used to adjust the axial thickness of ball ramp assembly 44 as friction disc 38 of primary service brake 32 wears over time. In contrast with known secondary brakes which utilize a dedicated friction disc, the present invention utilizes friction disc 38 of primary service brake 32 which experiences more wear, thus requiring the occasional adjustment of the thickness of ball ramp assembly 44.

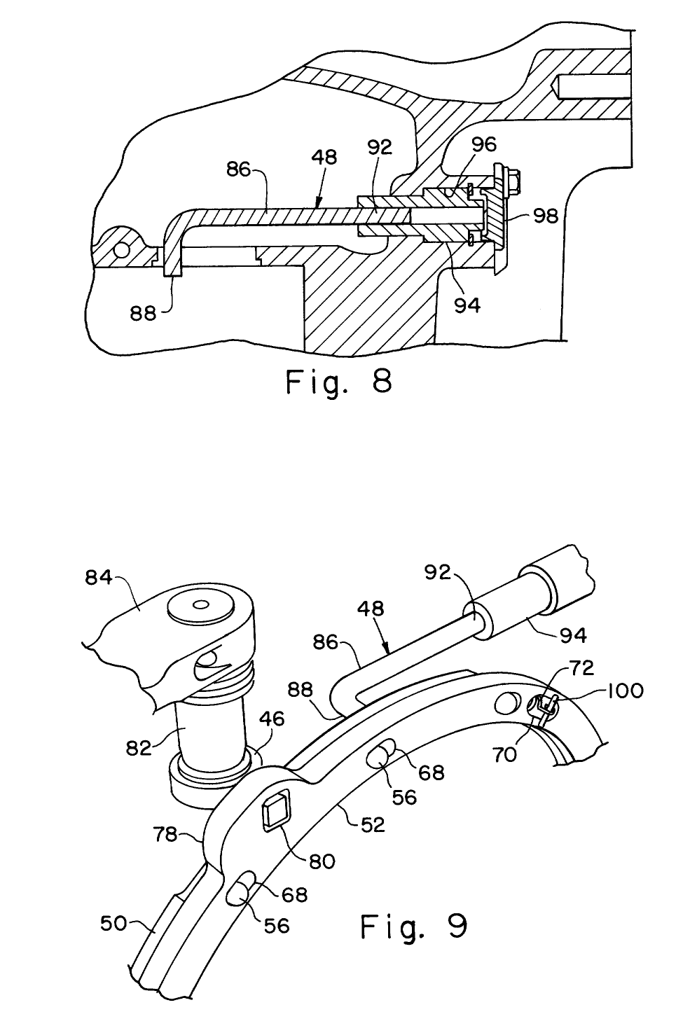

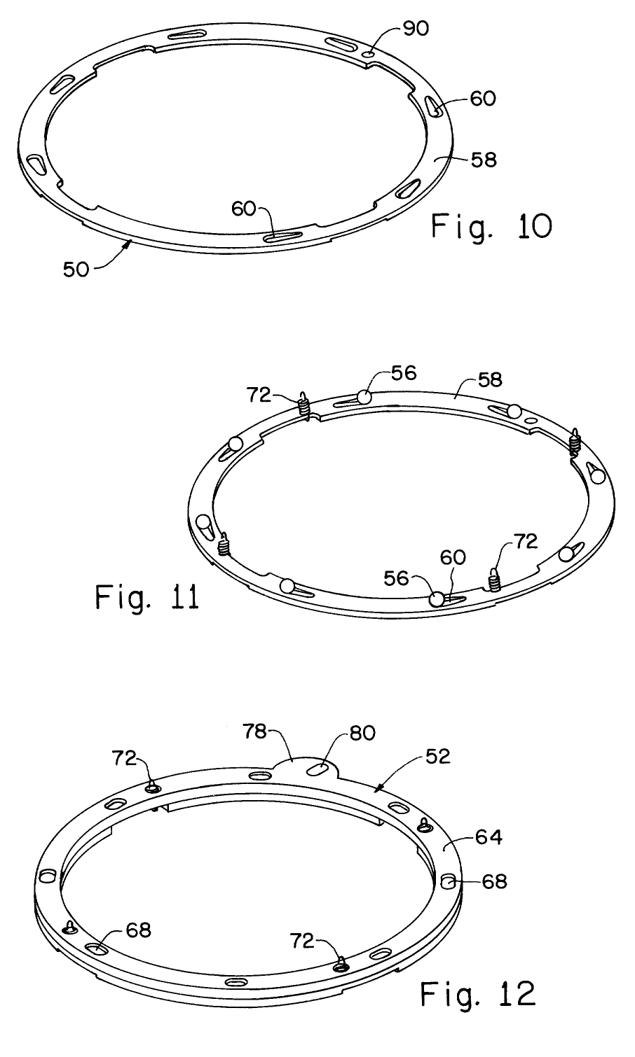

Adjustment mechanism 48 generally includes an adjustable link 86 which is coupled with inner plate 50 and accessible at the exterior of differential housing 28 (FIGS. 5, 8 and 9). In the particular embodiment shown, adjustable link 86 is in the form of a generally L-shaped link having an end 88 which is received within a hole 90 (FIG. 10) formed in inner plate 50. The L-shaped link 86 has an opposite end 92 with exterior threads which are threaded with an adjustment nut 94. Adjustment nut 94 is received within an opening 96 which is accessible at the exterior of differential housing 28. Opening 96 is closed by a cover 98 for the majority of the time when it is not necessary to access adjustment nut 94 (FIGS. 2, 3 and 8). Cover 98 may include flats which interface with adjustment nut 94 to prevent rotation of adjustment nut 94 when cover 98 is in place.

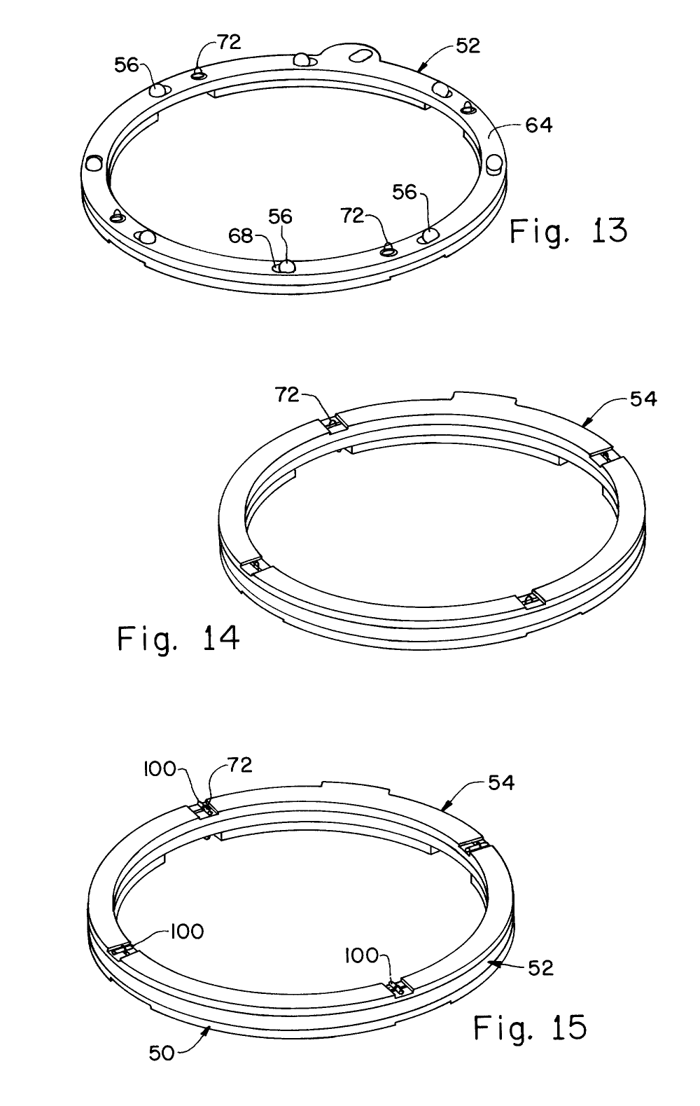

Referring to FIGS. 10-15, the general assembly of ball ramp assembly 44 will now be described. Inner plate 50 (FIG. 10) makes up an adjuster plate which is positioned with outer axial face 58 facing upward so that balls 56 may be placed within corresponding ball ramps 60. Springs 72 are also attached at one end thereof with inner plate 50 (FIG. 11). Center plate 52 defines an actuation plate which is positioned over inner plate 50 such that springs 72 extend through holes 70 in center plate 52. The location of holes 70 is such that balls 56 at the upper surface of inner plate 50 will align with ball ramps 66 at the inner axial face 62 of center plate 52. A second row of balls 56 is then added to the shorter actuation ball ramp 66 at outer axial face 64 of center plate 52 (FIG. 13). The outer plate 54 defines a reaction plate which is then placed over center plate 52 such that the opposite ends of springs 72 extend through slotted openings formed in outer plate 54 (FIG. 14). Springs 72 are then stretched slightly so that retainer pins 100 may be inserted to hold the entire ball ramp assembly 44 together (FIG. 15).

To adjust the axial thickness of ball ramp assembly 44 upon wear of friction disc 38 over time, cover 98 is removed from differential housing 28 and adjustment nut 94 is rotated. This in turn causes rotational movement of inner plate 50. Balls 56 within corresponding ramps 60 and 66 expand the axial gap between inner plate 50 and center plate 52, thereby increasing the overall thickness of ball ramp assembly 44.

To actuate secondary brake 34, actuation levers 84 are simultaneously actuated to cause the pair of actuators 46 on each side of differential housing 28 to engage a corresponding center plate 52. Center plate 52 moves in a direction as shown by arrow 102 in FIG. 7. This causes balls 56 between adjacent ramps 68 and 76 to increase the gap between center plate 52 and outer plate 54, thereby exerting a force against piston 36 and friction disc 38.

Having described the preferred embodiment, it will become apparent that various modifications can be made without departing from the scope of the invention as defined in the accompanying claims.

1. A brake for use in a work machine, said brake comprising:
an inner plate, a center plate and an outer plate which are generally coaxially arranged relative to each other, said inner plate including an outer axial face with a plurality of ball ramps, said center plate including opposite axial faces which each have a plurality of ball ramps, and said outer plate including an inner axial face with a plurality of ball ramps; and
a plurality of balls, each said ball positioned within one of said plurality of balls ramps of said center plate, and also positioned within one of said ball ramps of a corresponding one of said inner plate and said outer plate.

2. The brake of claim 1, wherein said brake is a secondary brake, and further including a friction disc associated with a primary service brake, said secondary brake adapted to apply a mechanical biasing force against said friction disc of the primary service brake.

3. The brake of claim 2, further including a hydraulically actuated piston associated with the primary service brake for applying a force to said friction disc, said secondary brake adapted to apply a mechanical biasing force against said piston, which in turn applies a mechanical biasing force against said friction disc.

4. The brake of claim 3, wherein said inner plate, said center plate and said outer plate are each positioned radially outward of said piston.

5. The brake of claim 2, including an adjustment mechanism for adjusting said brake relative to said friction disc, said adjustment mechanism including an adjustable link which is coupled with said inner plate.

6. The brake of claim 5, wherein said adjustable link is a generally L-shaped link with one end coupled with said inner plate, and another end threaded with an adjustment nut.

7. The brake of claim 6, wherein said inner plate includes a hole, and said one end of said L-shaped link is received within said hole.

8. The brake of claim 1, wherein said center plate includes an ear with an opening, and further including an actuator received within said opening for actuating said ball ramps.

9. The brake of claim 8, including an actuation lever attached to said actuator.

10. The brake of claim 1, wherein each of said inner plate, said center plate and said outer plate are generally ring shaped discs.

11. A brake for use in a work machine, said brake comprising:
a friction disc;
a ball ramp assembly, including:
an inner plate, a center plate and an outer plate which are generally coaxially arranged relative to each other, said inner plate including an outer axial face with a plurality of ball ramps, said center plate including opposite axial faces which each have a plurality of ball ramps, and said outer plate including an inner axial face with a plurality of ball ramps; and
a plurality of balls, each said ball positioned within one of said plurality of balls ramps of said center plate, and also positioned within one of said ball ramps of a corresponding one of said inner plate and said outer plate;
an actuator coupled with said center plate for actuating said ball ramps; and
an adjustment mechanism coupled with one of said inner plate and said outer plate for adjusting said ball ramp assembly relative to said friction disc.

12. The brake of claim 11, further including a hydraulically actuated piston associated with a primary service brake for applying a force to said friction disc, said ball ramp assembly being a secondary brake adapted to apply a mechanical biasing force against said piston, which in turn applies a mechanical biasing force against said friction disc.

13. The brake of claim 12, wherein said inner plate, said center plate and said outer plate are each positioned radially outward of said piston.

14. The brake of claim 13, including an adjustment mechanism for adjusting said ball ramp assembly relative to said friction disc, said adjustment mechanism including an adjustable link which is coupled with said inner plate.

15. The brake of claim 14, wherein said adjustable link is a generally L-shaped link with one end coupled with said inner plate, and another end threaded with an adjustment nut.

16. The brake of claim 15, wherein said inner plate includes a hole, and said one end of said L-shaped link is received within said hole.

17. The brake of claim 11, wherein said center plate includes an ear with an opening, and further including an actuator received within said opening for actuating said ball ramps.

18. The brake of claim 17, including an actuation lever attached to said actuator.

19. The brake of claim 11, wherein said adjustment mechanism is coupled with said inner plate.

20. The brake of claim 11, wherein each of said inner plate, said center plate and said outer plate are generally ring shaped discs.

21. A work machine, comprising:
an engine; and
a rear end coupled with said engine, said rear end including a pair of rear axles and a pair of rear brakes respectively associated with each rear axle, each said rear brake including:
a friction disc;
a ball ramp assembly, including:
an inner plate, a center plate and an outer plate which are generally coaxially arranged relative to each other, said inner plate including an outer axial face with a plurality of ball ramps, said center plate including opposite axial faces which each have a plurality of ball ramps, and said outer plate including an inner axial face with a plurality of ball ramps; and
a plurality of balls, each said ball positioned within one of said plurality of balls ramps of said center plate, and also positioned within one of said ball ramps of a corresponding one of said inner plate and said outer plate;
an actuator coupled with said center plate for actuating said ball ramps; and
an adjustment mechanism coupled with one of said inner plate and said outer plate for adjusting said ball ramp assembly relative to said friction disc.

22. The brake of claim 21, further including a hydraulically actuated piston associated with a primary service brake for applying a force to said friction disc, said ball ramp assembly being a secondary brake adapted to apply a mechanical biasing force against said piston, which in turn applies a mechanical biasing force against said friction disc.

23. The brake of claim 21 including an adjustment mechanism for adjusting said ball ramp assembly relative to said friction disc, said adjustment mechanism including an adjustable link which is coupled with said inner plate.

24. The brake of claim 21 wherein said center plate includes an ear with an opening, and further including an actuator received within said opening for actuating said ball ramps.
